(19) United States
(12) Patent Application Publication
(10) Pub. No.: US 2009/0214204 A1
(43) Pub. Date: Aug. 27, 2009

(54) Optical network monitoring using amplifier modeling

(76) Inventors: Thomas Bengtsson, Summit, NJ (US); Tin Kam Ho, Cedar Grove, NJ (US); Todd R. Salamon, Chatham, NJ (US); Christopher A. White, Neshanic Station, NJ (US)

Correspondence Address: HARNESS, DICKEY & PIERCE, P.L.C., P.O. BOX 8910, RESTON, VA, 20195, US

(21) Appl. No.: 12/071,450

(22) Filed: Feb. 21, 2008

(51) Int. Cl. H04B 10/08

(52) U.S. Cl. 398/38

(57) ABSTRACT

Example embodiments include a method for monitoring an optical network. The method provides received network data to a network model, which determines if there is an inconsistency within the optical network. The network models include a statistical model and a detailed-physical model, both of which model amplifier physics.

### BACKGROUND

Optically transparent mesh networks are large, complex networks having many spans of optical fiber and may use dense wavelength division multiplexing (DWDM). Signal power levels in the optical channels in these networks are adjusted on a periodic basis by sophisticated control schemes that attempt to meet pre-defined power targets specified by a set of design and engineering rules. Signal and channel are used interchangeably throughout the disclosure. These control schemes also compensate for power disturbances due to environmental changes, adding and/or dropping of channels in the network, aging of various optical components, and other factors beyond a service provider's control.

Optical networks may be designed to ensure that the channel power levels fall within certain desirable ranges as the channels propagate through the network. Typically, each channel in the system will have a target power. This is to minimize effects such as noise, which will dominate if the channel power level is too small, and nonlinearities, such as four-wave mixing, if the channel power level is too high. Optical network design thus attempts to minimize noise and nonlinearity effects by specifying target power levels (per-channel and/or over the fiber) at specific physical locations, for example, the output of an amplifier node in the optical network.

However, although the self-compensating nature of the control algorithms ensures that they will strive to reach desired network performance levels, they can also mask network impairments due to, for example, hardware failures, software bugs, incorrectly installed hardware, and hardware-specific provisioning parameters used in control algorithms, e.g. fiber type, fiber length, etc. These impairments can be masked until a system margin is exhausted, at which time catastrophic failure may occur. Due to the distributed nature of the network, the failure may occur at a point in the network separated by many network elements (and a large physical distance) from the location of the impairment. Therefore, a service provider may incur significant operational costs for network outages and in localizing the fault for repair.

The health of the optical network may be affected by factors including e.g.: i) the signals propagating on the network; and ii) the underlying hardware and software components comprising the network. Existing network management solutions focus primarily on the former, and hence are expected to be inadequate at diagnosing faults associated with the underlying hardware.

FIG. 1A illustrates two links of a conventional and/or existing optical mesh network, each link including one or more spans. Each link 200 may be a DWDM link having up to 128 channels, or possibly more, per fiber of the optical mesh network 500 and may connect various network elements and/or nodes in the optical mesh network 500. For example, link 200′ connects Dallas to Pensacola and link 200″ connects Pensacola to Atlanta. At the Atlanta node of the optical mesh network 500, there is a monitoring station 100. Monitoring station 100 may attempt to determine the health of the network 500 through existing network management software by monitoring, for example, amplifier nodes, optical add-drop multiplexers (OADMs), dynamic gain equalization filters (DGEFs), blockers, dispersion compensation modules (DCMs), non-pumped DCMs, in the network to meet the channel power targets specified by a set of engineering rules.

FIG. 1B illustrates an example of the elements of a representation of a Raman repeater, which may be used in the optical mesh network 500 of FIG. 1A. As shown, the representative Raman repeater node may include, optical amplifier pack (OA) 310, Raman pump pack (RP) 320, which may be similar to OA 310, fiber span 350, and connector losses 330 and 340. The OA 310 may include at least one co-propagating Raman pump. The RP 320 may include at least one counter-propagating Raman pump. The packs 310 and 320 may be integrated pieces of electronics that are part of a circuit pack or printed circuit board and may be swapped into and out of a corresponding shelf or rack for that amplifier node. The pack may also include pump lasers, which input energy into a fiber, along with associated electronics to control the pump lasers' power, etc. The OA and the RP may provide similar functionality, e.g. launching/inputting pump power at different wavelengths into the fiber span. The fiber span 350 may, for example, be 80 to 100 km in length. The connector losses 330 and 340 may include a collection of connector losses between the OA 310 and the fiber 350 and/or the fiber 350 and RP 320. The representative repeater node depicted in FIG. 1B, may correspond to uni-directional signal propagation along the fiber span, and is one representative configuration. Other configurations, such as bi-directional signal propagation on a fiber span, are also readily treated by the methodology and techniques described herein.

Adjustments to optical amplifiers in the system may be performed to ensure the measured optical channel powers match the targeted channel powers. In this manner, a network attempts to self-correct potential errors which arise as channel powers deviate from target. To maintain this stability, adjustments are made continuously (over time) to the amplifiers within the system. In the case of a Raman amplifier, the pump powers of a set of optical pump lasers need to be changed to maintain optimal channel powers. Generally no targets are placed on the pump laser values, they are adjusted based only on optimal system performance, although minimum and maximum power levels may be specified for reliability and safety considerations.

### SUMMARY OF THE INVENTION

Example embodiments seek to monitor optical networks, for example methods to estimate when a network is masking impairments and to determine the location and nature of these impairments, thus leading to robust network operation and reduced costs for network operation and deployment. Example embodiments may also have application to initial system development and debugging.

Example embodiments include a method for automatic monitoring at a monitoring station. The method includes receiving at the monitoring station, at least measured optical network data for a span of the optical network and determining whether the received optical network data is consistent with modeled optical network data determined from at least one optical network model. The optical network model models the physics of amplifiers in at least one span of the optical network. The optical network model may also model Raman amplifiers. The model may include at least one of a physics-based statistical model, referred to as an “R-beta model” and a detailed-physical model.

When an inconsistency is determined, an alarm may be activated, including alarms of an audible, visual, tactile, and/or any combination thereof type. The modeled data may also be presented to illustrate whether there is an inconsistency or not, by display, hard-copy, graph, chart, verbally, and/or any combination thereof. Example embodiments may be performed repeatedly at various intervals, e.g. continuously, every minute, hourly, daily, periodically etc.

### BRIEF DESCRIPTION OF THE DRAWINGS

Example embodiments will be more clearly understood from the following detailed description taken in conjunction with the accompanying drawings. FIGS. 1-4 represent non-limiting, example embodiments as described herein.

FIG. 1A illustrates an exemplary representation of a known optical network between Dallas, Pensacola, and Atlanta;

FIG. 1B illustrates elements of a known Raman repeater node, used in the optical network of FIG. 1A, the direction of signal propagation from left to right in the diagram;

FIG. 2 shows a flow chart of an example embodiment of a monitoring method;

FIG. 3 shows a flow chart of an example embodiment of a first statistical model referred to as the R-Beta model used in the monitoring method shown in FIG. 2;

FIG. 4 shows a flow chart of an example embodiment of a second model referred to as the detailed-physical model used in the monitoring method shown in FIG. 2;

FIG. 5 shows an example monitoring station according to an embodiment of the present invention.

### DETAILED DESCRIPTION OF EXAMPLE EMBODIMENTS

Various example embodiments will now be described more fully with reference to the accompanying drawings in which some example embodiments are illustrated.

Detailed illustrative embodiments are disclosed herein. However, specific structural and functional details disclosed herein are merely representative for purposes of describing example embodiments. This invention may also be embodied in many alternate forms and should not be construed as limited to only example embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g. those defined in commonly used dictionaries, should be interpreted as having a meaning that is consistent with their meaning in the context of the relevant art and will not be interpreted in an idealized or overly formal sense unless expressly so defined herein.

It should be noted that example embodiments may be performed by a computer if the method is encoded on a computer readable medium. Such computer readable mediums, may include CDs, DVDs, memory devices, ROM, RAM, Flash drives, etc. In the following description, illustrative embodiments will be described with reference to acts and symbolic representations of operations (e.g., in the form of flowcharts) that may be implemented as program modules or functional processes including routines, programs, objects, components, data structures, etc., that perform particular tasks or implement particular abstract data types and may be implemented using existing hardware at existing network elements or control nodes (e.g., a monitoring station at a network node or at a control center that is outside the network but may access the network nodes remotely). Such existing hardware may include one or more digital signal processors (DSPs), application-specific-integrated-circuits, field programmable gate arrays (FPGAs), computers, etc.

Example embodiments will now be described more fully with reference to the accompanying drawings, in which exemplary embodiments of the invention are shown. The example embodiments may, however, be embodied in many different forms and should not be construed as being limited to the embodiments set forth herein. Rather, these embodiments are provided so that this disclosure will be thorough and complete, and will fully convey the scope of the invention to one of ordinary skill in the art. In the drawings, the sizes of constitutional elements may be exaggerated for convenience of illustration.

The example embodiments assess if the signal gain across a fiber span is consistent with the amplification level of the pumps being input to the fiber span. Specifically, models of the Raman gain physics are combined with statistical estimation, which result in methods and apparatuses that allow detection of anomalous conditions. The method focuses on detecting the network behavior that is inconsistent with Raman physics, and hence may capture more complex anomalies not readily recognized by an engineering-rule-based approach.

For Raman and other amplifier types, the quantity (output-input-attenuation) and the shape of the amplifier gain, is dictated by the underlying amplifier physics. Gain may be defined as the ratio between received and transmitted channel power at specific points along a fiber. The gain may also be determined along a span, node, section, etc. If the gain profile or gain shape is inconsistent with expected system behavior, it is an indication that something in the system is affecting the measured gain shape. These changes are termed anomalies and/or inconsistencies, since they indicate in some fashion the system is behaving in an unexpected manner. These anomalies may not indicate a failure to transmit information, but they do indicate a possible future problem in the network.

Two primary mathematical models of the amplifier physics are described below: (1) a physics-based statistical model, referred to as the R-Beta model, which approximates the fiber span behavior as comprising two dominant physical effects, namely fiber attenuation and pump-signal Raman amplification; and (2) a detailed physical model, which may be a function of at least one of input channel power, input pump power, fiber type (e.g. based on manufacturer and fiber characteristics), attenuation loss, input connector losses, output connector losses, Rayleigh back-scattering, and temperature (e.g. fiber temperature).

The R-Beta model is a statistical model that accounts for pump-signal amplification by modeling the Raman gain via the path-total power over a determined span. The path total power is the integral and/or sum of pump powers in certain frequency ranges over a determined fiber length. This model may be used to detect gain deviations that are not consistent with Raman physics. Examples of such deviations are those due to power measurement errors, mis-fibering (e.g., connecting the wrong fiber to a device), various network monitor failures, and power measurement calibration errors, e.g. optical monitor (OMON) calibration errors.

The detailed physical model represents a description of various physical phenomena occurring in a Raman amplified span, e.g. a span in which the amplification takes place throughout the span. The detailed physical model may include any or all effects which contribute in a significant manner to the expected gain profile for a typical Raman amplified span of the network, e.g. both stimulated and spontaneous Raman interactions, fiber attenuation, Rayleigh back-scattering effects and connector loss effects, etc. Through simulation and direct comparison, this model may detect anomalous behavior within the optical network. For different fibers or expected optical power levels, the detailed model may be augmented with additional terms (e.g. four-wave mixing, stimulated Brillouin scattering, etc.) which may be required to obtain a quantitative agreement between simulation and measurement.

In the detailed-physical model, input powers are used to compute an expected gain profile. If the expected gain profile differs from the measured gain profile, there is the possibility of an anomaly. However, there are many effects which may cause the computed or modeled gain profile to differ from a determined gain profile. Therefore, to match the model to the determined, adjustments to one or more input parameters may be required. To the extent that adjustments are necessary, and require adjustments to parameters that may result in impossible or unphysical values, the detailed-physical model may indicate a potential anomaly.

With both models, the expected behavior of various failure scenarios can be established using large-scale simulations and corresponding alarms, the alarms being used to indicate network anomalies/inconsistencies and/or the type of anomaly/inconsistency. The proposed alarms may be used in combination with traditional rule-based approaches and data visualization of the optical network to provide a diagnostic tool for optical networks that use Raman amplifiers.

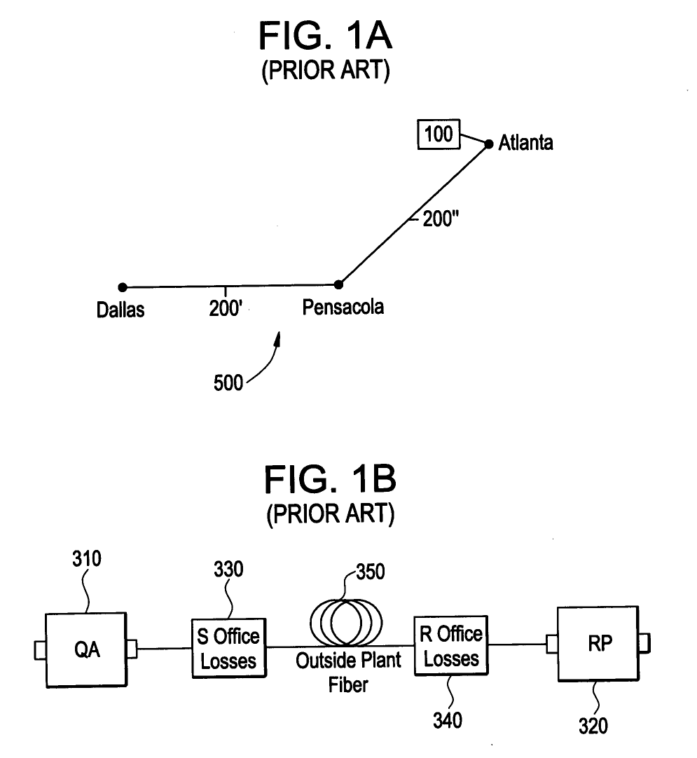

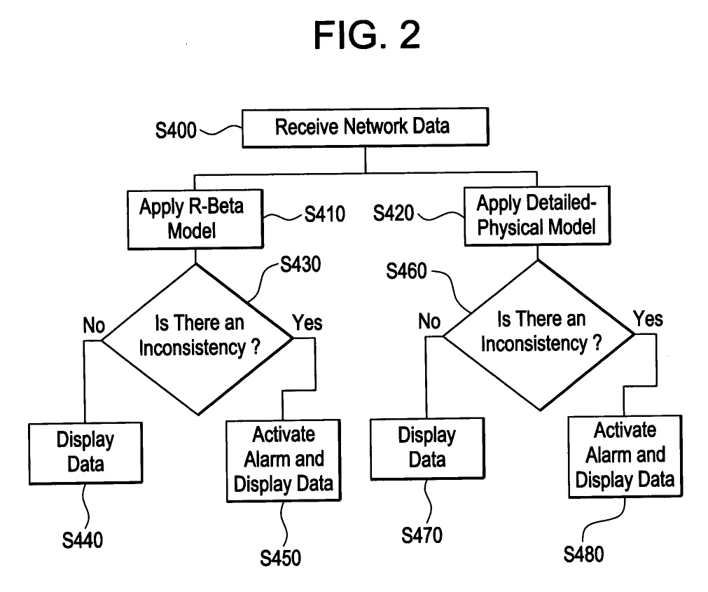

FIG. 2 shows a flow chart of an example embodiment of the monitoring method. This method will be described as employed at the monitoring station 100 of FIG. 1A for the purposes of example only. Namely, it will be understood that example embodiments may be embodied in many different forms and should not be construed as being limited to the embodiments set forth herein. The monitoring station 100 may include one or more programmable computers programmed to perform the method shown in FIG. 2. In alternative embodiments, portions of the monitoring method and thus the monitoring station may be distributed throughout the optical network

As shown, the monitoring station 100 receives network data in step S400. The received network data may be obtained using data queries sent out to the optical network and retrieving and/or receiving the requested optical data in response. The optical data may include both measured and observed data as well as network provisioned value for various parameters. The optical data may include, for example, input and output channel powers, channel wavelengths, channel frequencies, pump frequencies, pump wavelengths, input and output pump powers, and provisioned values of physical properties for a fiber span, including e.g. fiber type, fiber length, total span losses, and connector losses. The pump wavelengths/frequencies may be provisioned by the network and the pump powers may adjust over time as required by the network.

Example embodiments may include a charting tool (not shown) that produces a set of inference-assisting graphical summaries of the optical network state at the monitoring station 100. These displays are designed to highlight the data distributions from both spatial and spectral views of the network, as well as to show various indicators of the system performance and health.

The monitoring station 100 applies the received data to at least one statistical model, e.g. the R-Beta model in step S410 and/or the detailed-physical model in step S420. The R-Beta model and the detailed-physical model will be further described below.

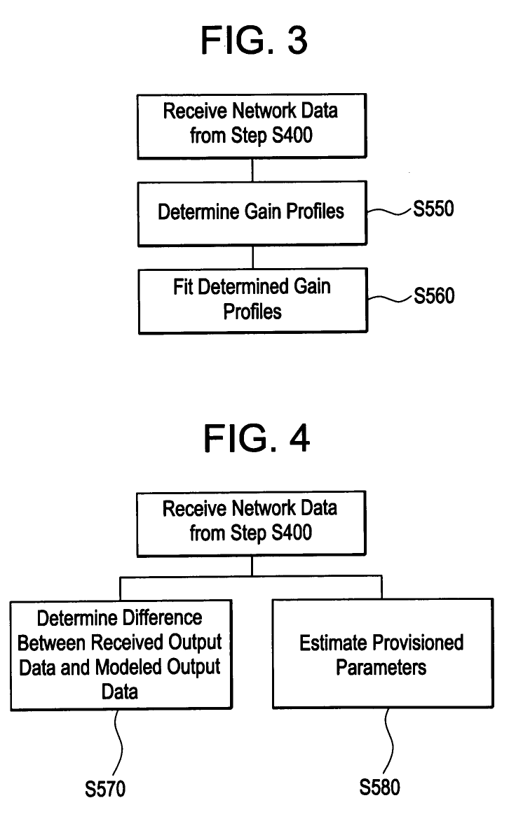

FIG. 3 illustrates a flow chart of the R-Beta model performed by the monitoring station according to an embodiment of the present invention. As shown, the network data is received from step S400. The received data may include measured network data, e.g. input and output powers of at least one optical channel and provisioned data, e.g. corresponding channel wavelengths and sets of amplifier wavelengths. At step S550 a determined gain profile based on the received network data is determined. Also at step S550, a modeled set of possible gain profiles according to Raman physics using the R-Beta model is determined. The modeled set of possible gain profiles is a function of a Raman gain profile R, which is a measured property of the fiber, and path-total power β.

The monitoring station 100 then compares the determined gain profile to the modeled gain profile e.g. using linear regression techniques at step S560. The flow then returns to FIG. 2, where a determination is made in step S430 as to whether there is an inconsistency and/or an anomaly in the optical network. The determination in step S430 is based on how well the determined gain profile fits the modeled possible set of gain profiles that are consistent with Raman physics. This determination is then compared to a threshold that may be empirically determined and if the determination is outside the threshold, then an inconsistency is determined to exist in the optical network. For example, a difference between the determined gain profile and the set of modeled gain profiles may be compared to a threshold value and/or the determination may be based on whether a determined gain profile falls within an acceptable range of values having an upper and lower threshold. If an inconsistency is determined at step S430, then a flag indicative of the inconsistency is set which may be used to activate an alarm and the received and/or determined data may be presented to a user at step S450. For example, when no inconsistency is determined at step S430, then the received data and/or the determined data may be presented to a user at step S440.

Alternatively, or additionally, as shown in FIG. 2, the received data from step S400 at the monitoring station may be applied to the detailed-physical model at step S420. FIG. 4 illustrates a flow chart of the detailed-physical model performed by the monitoring station 100, according to an embodiment of the present invention.

As shown, the collected optical network measurements are received from step S400. At step S570, the detailed-physical model determines the difference between received output data and modeled output data. The received data may include measured network data, e.g. input channel power, output channel power, input pump power, output pump power, etc., and provisioned data, e.g. connector losses, fiber attenuation, Raman gain coefficient, etc. For example, received values for input channel power and/or input and output pump powers and various provisioned parameters may be used by the detailed-physical model to predict a set of modeled output gain profiles, similar to the manner in which the R-Beta model functions. Other possible output data may include modeled output power. As indicated above, the detailed-physical model considers received data, as well as, e.g. pump powers and various provisioned parameters, e.g. connector loss, etc.

Alternatively or additionally, at step S580 the detailed-physical model may estimate provisioned parameter values. For example, the detailed-physical model may use measured input and output channel powers and input pump powers, to estimate, e.g. one of the provisioned parameters, e.g. connector losses, Raman gain coefficient, fiber attenuation, etc.

The flow from both steps S570 and/or S580 then returns to FIG. 2, where a determination is made in step S460 as to whether there is an inconsistency and/or an anomaly in the optical network. The determination in step S460 may be performed in various ways, two of which are discussed below as example embodiments.

First, the determination may be based on a determination of how well the determined gain profile fits the modeled possible set of gain profiles that are consistent with Raman physics. The determination is then compared to a threshold that may be empirically determined and if the determination is outside the threshold, then an inconsistency is determined to exist in the optical network. These inconsistencies may include measurement errors, e.g. OMON errors, mis-fibering, incorrectly calibrated pump values, software bugs, etc.

Second, the determination may be based on a determination of the difference between the provisioned parameters having a nominal value and the modeled parameters. The determination is then compared to a threshold that may be empirically determined and if the determination is outside the threshold, then an inconsistency is determined to exist in the optical network. These inconsistencies may include anomalous or incorrectly provisioned physical property information, e.g. fiber attenuation, connector losses, Raman gain coefficient.

If an inconsistency is determined at step S460, then an alarm is activated and the received and/or determined data may be presented to a user at step S480. If no inconsistency is determined at step S460, then the received data and/or the determined data may be presented to a user at step S470. The example embodiment methods may be preformed repeatedly at various intervals, e.g. continuously, every minute, hourly, daily, or at some predetermined time interval etc.

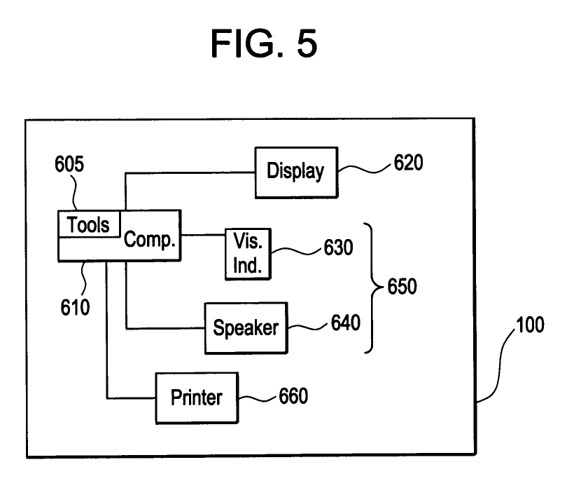

As shown in FIG. 5, at the monitoring station 100, there may be a computer system 610 having various tools 605 including programs etc. that may be used to receive, interpret and present the received, modeled, and analyzed data. Computer system 610 may also include various well known components, e.g. a receiver for receiving data, a transmitter for transmitting data, processors for determining whether there is an inconsistency in the optical network and/or memory for storing various data. The monitoring station 100 may also include at least one display 620, at least one alarm 650, which may include at least one separate visual indicator 630 and/or at least one speaker 640, and at least one printer 660. The alarm 650 may include any alarm that will attract a user's attention such as audible alarms (e.g. using speaker 640), visual alarms (e.g. using visual indicator 630), tactile alarms, etc. or any combination thereof. Additionally, the presentation of the data may be used to attract a user's attention and may be provided on display 620, which may be, for example, a TV screen, a computer screen, a hard-copy print out, a graph, a chart, and/or described verbally through a speaker 660, electronic communication, e.g. email, etc. or any combination thereof.

Presenting the data may include using any well-known system-level analysis and well-known presentation tools that perform additional system-level diagnostics and combine the alarms reported on each polled span and the corresponding diagnostic charts into a hierarchical presentation. The system-level analysis tool provides correlation of alarms and root-cause analysis capability via easy to read display summaries of network alarms, including those generated by the model-based approaches and traditional engineering-rule based approaches.

While both the R-Beta model and the detailed-physical model may be used in parallel as shown in FIG. 2, a traditional engineering-rule based model program (not shown) may also be used to alert users of possible inconsistencies.

Example embodiments of the R-Beta model and the detailed-physical models are further described below.

### R-Beta Model

The following equation approximates the evolution of the channel power p (z, λᵢ) at channel wavelength λᵢ as a function of distance z along the fiber in a Raman-amplified fiber span

$$\frac{d p ( z , {λ}_{i} )}{d z} = - α ( {λ}_{i} ) p ( z , {λ}_{i} ) + {\sum }_{j = 1}^{{N}_{pumps}} R ( {λ}_{i} , {λ}_{j} ) p ( z , {λ}_{i} ) p ( z , {λ}_{i} ) \qquad ( 1 )$$

In (1); p(z,λⱼ) denotes the pump power at pump at spatial location z and wavelength λⱼ, α(λᵢ) is the fiber attenuation coefficient at wavelength λᵢ, R(λᵢ,λⱼ) is the Raman gain coefficient between the pump at wavelength λⱼ and the signal at wavelength λᵢ, and Nₚᵤₘₚₛ is the number of pumps. The relationship in (1) can be alternatively expressed by dividing by p (z,λᵢ) and integrating both sides from z=0 to L, the fiber length, resulting in the following equation

$$ln p ( L , {λ}_{i} ) - ln p ( 0 , {λ}_{i} ) + α ( {λ}_{i} ) L \approx {\sum }_{j = 1}^{{N}_{pumps}} R ( {λ}_{i} , {λ}_{j} ) {β}_{j} , \qquad ( 2 )$$

where βⱼ=∫₀^{L}p(z,λⱼ)dz represents the pump power integrated over the length of the fiber span. Denote the left hand side of (2), the attenuation-adjusted gain for channel i, by

δᵢ≡ln p(L,λᵢ)−ln p(0,λᵢ)+α(λᵢ)L, (3)

and let Δ=[δ₁, . . . δ . . . ]^{T} contain k adjusted gains. Further, with R being a k×Nₚᵤₘₚₛ matrix with elements Rᵢⱼ≡R(λᵢ,λⱼ), (2) can be expressed as

Δ≈Rβ (4)

Linear regression techniques can be used to fit a set of observed signal gains Y to (4), i.e.

Y=Rβ+ε (5)

Here, the quantity ε measures the gain across the Raman-amplified span that is not captured by the Rβ model in (4). The magnitude of this term, ∥ε∥ is a measure of how well the actual measured data is described by the R-Beta amplification model, independent of particular pump levels. The residual ε may include measurement noise, measurement errors, physical effects left out by the R-Beta approximation, and the effects of any potential anomalies.

### The Detailed Physical Model

The detailed-physical model may be a more comprehensive model for Raman-amplification, which modifies the R-Beta model. The detailed-physical model may include terms that account for signal-signal Raman pumping, noise generation and Rayleigh back-scattering in the Raman span as well as effects such as connector and splice losses. The detailed-physical model may be represented via the following equation:

y^{s}(L)=f(y^{s}(0),P^{f}(0),P^{b}(L),α(ν),γ(ν),g(v,ζ)),Δ^{s},Δ^{R}), (6)

which expresses the received signal powers y^{S}(L) as a function ƒ(·) of: the launch signal powers y^{S}(0), the launch powers of the co- and counter-propagating Raman pumps P^{ƒ}(0) and P^{b}(L), the fiber attenuation coefficient α(ν) at frequency ν, Rayleigh back-scattering coefficient γ(ν), Raman gain coefficient g(ν, [symbol] ) for a pair of frequencies ν and ζ, and the connector and splice losses Δ^{S} and Δ^{R} at the launch (z=0) and receive locations (z=L).

Some of the key physical parameters controlling the Raman span behavior are the attenuation coefficient α(ν), the Raman gain coefficient g(ν, [symbol] ), the fiber length L, and the connector losses Δ^{S}, Δ^{R}. Values for L, α(ν) and total connector loss (Δ^{S}+Δ^{R}) can be estimated from OTDR (Optical Time Domain Reflectometry) and total span loss measurements, while nominal values for the Raman gain coefficient g(ν, [symbol] ) may be typically used.

The detailed physical model may be used to produce inconsistency alarms, for example, in the following ways: (i) measured signal powers at z=0 and pump powers at both z=0 and z=L are used to predict signal powers at z=L, and the predicted values are then compared to measured signal powers at z=L; and/or (ii) a maximum likelihood procedure is used to estimate the connector losses (Δ^{S},Δ^{R}), which are compared to provisioned values. Discrepancies observed in either (i) or (ii) indicate inconsistencies.

Example embodiments describe a model-based approach for anomaly and/or inconsistency detection and monitoring in optical networks. Example embodiments model Raman amplifiers, but the methodology is readily extendable to other amplification techniques, such as Erbium-Doped Fiber Amplifier (EDFA) based devices, blockers and non-pumped DCMs (Dispersion compensating modules). As will be appreciated from the disclosure, these techniques may also be extended to examining other measures of performance, such as optical signal-to-noise ratio, bit error rate and dispersion, etc.

Example embodiments of the present invention being thus described, it will be obvious that the same may be varied in many ways. Such variations are not to be regarded as a departure from the invention, and all such modifications are intended to be included within the scope of the invention.

What is claimed is:

1. A method for automatic monitoring of an optical network, the method comprising:
receiving optical network data at a monitoring station, the received optical network data including at least measured optical network data for a span of the optical network; and
determining whether the received optical network data is consistent with modeled optical network data determined from at least one optical network model, the optical network model modeling the physics of amplifiers in a span of the optical network.

2. The method of claim 1, wherein the at least one optical network model is a model of a Raman amplifier.

3. The method of claim 1, wherein the received optical network data includes,
at least one input and output channel power and corresponding channel wavelengths; and
at least one set of amplifier powers and corresponding wavelengths.

4. The method of claim 1, wherein the determining step comprises:
determining a gain profile from the received optical network data;
determining a modeled gain profile from an optical network model; and
fitting the determined gain profile to the modeled gain profile.

5. The method of claim 4, further comprising:
determining at least one inconsistency in the optical network if the fitting of the determined gain profile to the modeled gain profile is outside a predetermined tolerance.

6. The method of claim 2, wherein the at least one optical network model is a function of at least one of input channel powers, output channel powers, Rayleigh back-scattering, splice losses, Raman pump powers, Raman gain coefficients, fiber attenuation, and connector losses.

7. The method of claim 6, wherein the received optical network data includes,
at least one input channel power;
at least one output channel power; and
at least one input pump power.

8. The method of claim 7, wherein the determining step comprises:
determining at least one modeled output channel power from an optical network model; and
determining the difference between the at least one output channel power and the at least one modeled output channel power.

9. The method of claim 8, further comprising:
determining at least one inconsistency in the optical network if the determined difference between the at least one output channel power and the at least one modeled output channel power is greater than a predetermined threshold.

10. The method of claim 6, wherein the determining step comprises:
determining at least one estimated provisioned parameter; and
determining a difference between the estimated provisioned parameter and at least one nominal value of the provisioned parameter.

11. The method of claim 10, further comprising:
determining at least one inconsistency in the optical network if the determined difference between the estimated provisioned parameter and the at least one nominal value of the provisioned parameter is greater than a predetermined threshold

12. The method of claim 1, further comprising:
activating an alarm if an inconsistency is determined, the alarm including at least one alarm that is audible, visual, tactile, or any combination thereof.

13. The method of claim 1, wherein the method is performed continuously.

14. The method of claim 1, wherein the method is performed periodically or at a predetermined time interval.

15. The method of claim 1, further comprising:
presenting the determination as to whether there is an inconsistency, wherein the presenting includes modeled results from the at least one optical network model.

16. The method of claim 15, wherein the presenting includes at least one of display, hard-copy, graph, chart, verbal, and any combination thereof.

17. A computer readable medium encoded with a method for automatic monitoring of an optical network, the method comprising:
receiving optical network data at a monitoring station including at least measured optical network data for a span of the optical network; and
determining whether the received optical network data is consistent with modeled optical network data determined from at least one optical network model, the optical network model modeling the physics of amplifiers in a span of the optical network.

18. A monitoring station comprising:
receiver for receiving optical network data including at least measured optical network data for a span of the optical network; and
controller for determining whether the received optical network data is consistent with modeled optical network data determined from at least one optical network model, the optical network model modeling the physics of amplifiers in a span of the optical network.
